(19) United States
(12) Patent Application Publication
(10) Pub. No.: US 2020/0200392 A1
(43) Pub. Date: Jun. 25, 2020

(54) ELECTRIC FIREPLACE WITH SIMULATED BRICKS

(71) Applicant: Dong Guan Song Wei Electric Technology Co., Ltd., Dongguan (CN)

(72) Inventor: Weilin Lu, Dongguan (CN)

(21) Appl. No.: 16/226,671

(22) Filed: Dec. 20, 2018

(51) Int. Cl. F24C 7/00; F21S 10/04; F24B 1/18

(52) U.S. Cl. CPC F24C 7/004; F24B 1/1808; F21S 10/046

(57) ABSTRACT

An electric fireplace includes a housing, a main control board, a flame processing device, a simulated wood, a light-emitting device, a light-reflecting device, and simulated bricks. All the inner walls of an accommodating chamber of the housing are bonded with the simulated bricks to form a three-dimensional brick wall effect. The flame-shaped light projects on the simulated bricks from a gap between the rear inner wall of the accommodating chamber and the simulated wood, enabling the flame burning effect of the electric fireplace to more three-dimensional.

### BACKGROUND OF THE INVENTION

### 1. Field of the Invention

The present invention relates to an electric fireplace, and more particularly to an electric fireplace with simulated bricks.

### 2. Description of the Prior Art

In the early days, a fireplace may be used for lighting, warming, grilling food. With the development of economy and technology, the three functions of lighting, warming, grilling food are gradually improved and separated.

These days, a fireplace becomes warming equipment. With the development of times, fireplaces are improved from the traditional fireplaces, such as wood burning fireplaces, fuel gas fireplaces or charcoal fireplaces, to electric fireplaces. The electric fireplaces come from the European classical fireplaces in cooperation with acoustics and optics technique, which has greatly improved the design of the traditional fireplace. The electric fireplaces are green and friendly-environmental and provide a realistic burning effect. Usually, electric fireplaces have a flame imaging screen through which the flame simulation effect of the electric fireplace is presented. However, the concave and convex effect of the panel of the flame imaging screen is not strong, and there is no realistic three-dimensional wall effect, which makes the three-dimensional effect of the flame of the electric fireplace not good, which reduces the ornamental of the electric fireplace. Accordingly, the inventor of the present invention has devoted himself based on his many years of practical experiences to solve this problem.

### SUMMARY OF THE INVENTION

In view of the shortcomings of the prior art, the primary object of the present invention is to provide an electric fireplace with simulated bricks, which can solve the problem that the conventional electric fireplace has no realistic three-dimensional wall effect and that the flame three-dimensional effect is not good.

In order to achieve the above object, the present invention adopts the following technical solutions:

An electric fireplace comprises a housing, a main control board, a flame processing device, a simulated wood, a light-emitting device, a light-reflecting device, and simulated bricks. A front of the housing is recessed to form an accommodating chamber. The accommodating chamber has an opening covered with a transparent front door. The main control board is disposed inside the housing. The flame processing device is disposed at a bottom of the accommodating chamber and located in front of a rear inner wall of the accommodating chamber. The simulated wood is disposed at the bottom of the accommodating chamber and located in front of the flame processing device. The simulated wood extends obliquely rearward and upward. A top of the simulated wood is connected to a top of the flame processing device. A gap is defined between the simulated wood and the rear inner wall of the accommodating chamber as well as between the flame processing device and the rear inner wall of the accommodating chamber. The housing has a mounting cavity surrounded by the simulated wood, the flame processing device and an inner bottom surface of the accommodating chamber. The light-emitting device and the light-reflecting device are disposed in the mounting cavity. The light-emitting device is located under the flame processing device. The light-emitting device is electrically connected to the main control board. The light-reflecting device is located obliquely above the light-emitting device and in front of the flame processing device. The light-reflecting device is connected to the main control board. The simulated bricks are attached to the inner wall of the accommodating chamber.

Compared with the prior art, the present invention has obvious advantages and beneficial effects. Specifically, it can be known from the above technical solutions:

All the inner walls of the accommodating chamber are bonded with the simulated bricks to form a three-dimensional brick wall effect. The flame-shaped light projects on the simulated bricks from the gap between the rear inner wall of the accommodating chamber and the simulated wood, enabling the flame burning effect of the electric fireplace to be more three-dimensional. The invention does not need to use an imaging screen, and has a simpler structure and a lower cost.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is a front view according to the first embodiment of the present invention;

FIG. 4 is a cross-sectional view according to the first embodiment of the present invention;

FIG. 5 is a perspective view according to a second embodiment of the present invention;

FIG. 6 is a partial exploded view according to the second embodiment of the present invention;

FIG. 7 is a front view according to a third embodiment of the present invention;

FIG. 8 is a perspective view according to the third embodiment of the present invention;

FIG. 9 is a perspective view according to a fourth embodiment of the present invention;

FIG. 10 is a partial exploded view according to the fourth embodiment of the present invention;

FIG. 11 is a cross-sectional view according to the fourth embodiment of the present invention;

FIG. 12 is a perspective view according to a fifth embodiment of the present invention; and

FIG. 13 is a front view according to the fifth embodiment of the present invention.

### DETAILED DESCRIPTION OF THE PREFERRED EMBODIMENTS

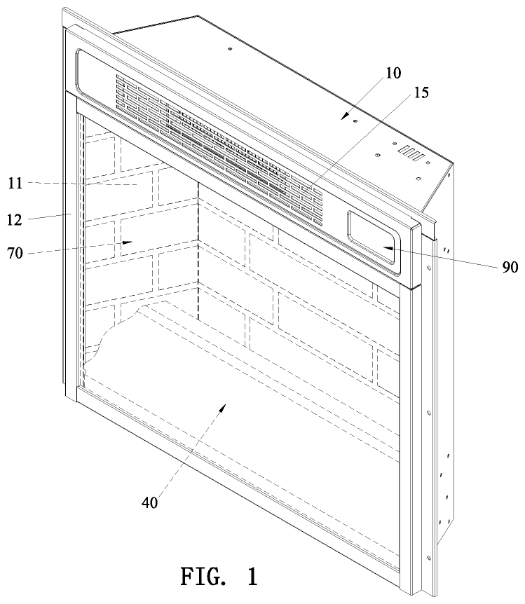

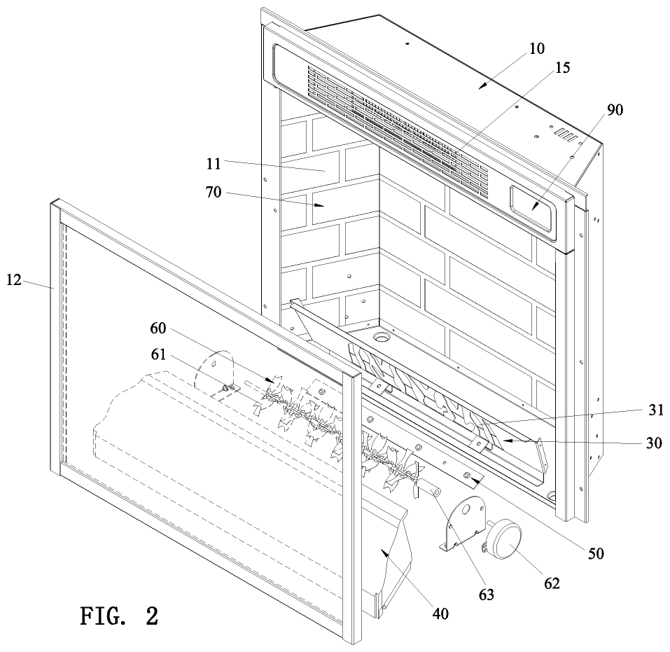

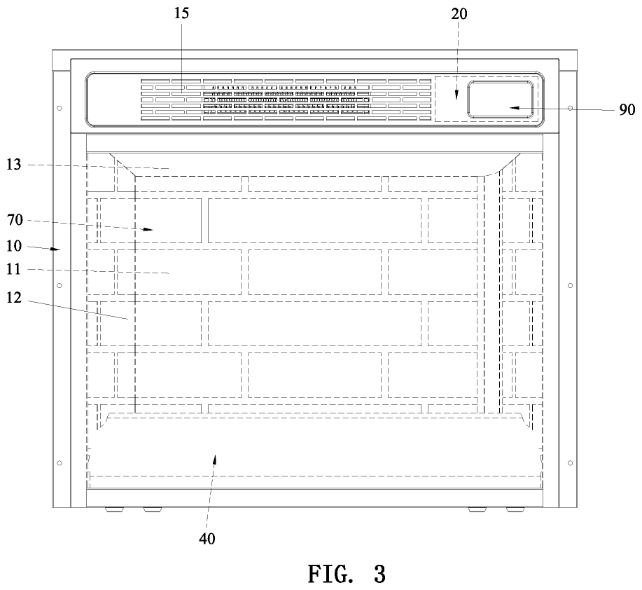

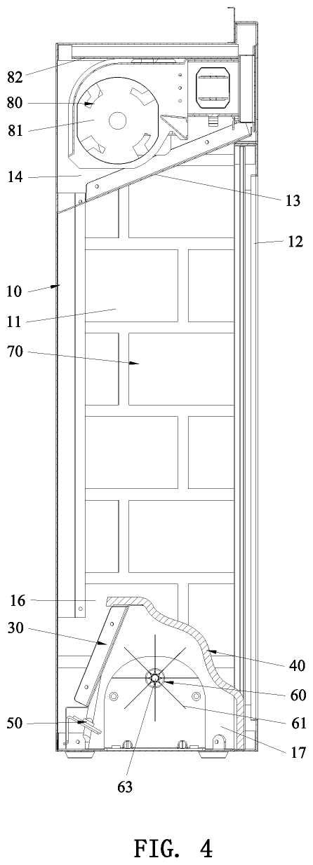

Please refer to FIG. 1 to FIG. 4, which shows a specific structure of a first embodiment of the present invention, comprising a housing 10, a main control board 20, a flame processing device 30, a simulated wood 40, a light-emitting device 50, a light-reflecting device 60, and simulated bricks 70.

The front of the housing 10 is recessed to form an accommodating chamber 11. The accommodating chamber 11 has an opening covered with a transparent front door 12. In the embodiment, the upper inner wall of the accommodating chamber 11 is provided with a light-blocking plate 13. The light-blocking plate 13 extends obliquely forward and upward. The top of the housing 10 has a cavity 14. The front of the housing 10 is provided with an air outlet 15. The air outlet 15 is located on the front of the upper portion of the housing 10 and communicates with the cavity 14.

The main control board 20 is disposed inside the housing 10. In this embodiment, the main control board 20 is connected with a control panel 90. The control panel 90 is exposed at the upper right corner of the front of the housing 10.

The flame processing device 30 is disposed at the bottom of the accommodating chamber 11 and located in front of the rear inner wall of the accommodating chamber 11. In this embodiment, the flame processing device 30 is a flame-shaped retaining plate that has a plurality of flame-shaped holes 31 and extends obliquely forward and upward.

The simulated wood 40 is disposed at the bottom of the accommodating chamber 11 and located in front of the flame processing device 30. The simulated wood 40 extends obliquely rearward and upward. In this embodiment, the top of the simulated wood 40 is connected to the top of the flame processing device 30. A gap 16 is defined between the simulated wood 40 and the rear inner wall of the accommodating chamber 11 as well as between the flame processing device 30 and the rear inner wall of the accommodating chamber 11. The housing 10 has a mounting cavity 17 surrounded by the simulated wood 40, the flame processing device 30 and the inner bottom surface of the accommodating chamber 11.

Both the light-emitting device 50 and the light-reflecting device 60 are disposed in the mounting cavity 17. The light-emitting device 50 is located under the flame processing device 30. The light-emitting device 50 is electrically connected to the main control board 20. The light-emitting device 50 is an LED light source that illuminates forward and upward. The light-reflecting device 60 is located obliquely above the light-emitting device 50, and the light-reflecting device 60 is located in front of the flame processing device 30. The light-reflecting device 60 is connected to the main control board 20. In this embodiment, the light-reflecting device 60 includes a light-reflecting beam 61 and a motor 62. The light-reflecting beam 62 is fitted on a rotating shaft 63. The motor 62 is disposed on the housing 10 and connected to one end of the rotating shaft 63. The motor 62 drives the light-reflecting beam 61 to rotate through the rotating shaft 63. The motor 62 is connected to the main control board 20. The motor 62 is a synchronous motor or other common motor, etc.

The simulated bricks 70 are attached to all the inner walls of the accommodating chamber 11 to form a three-dimensional brick wall effect. In this embodiment, the simulated bricks 70 are flexible adhesive simulated bricks.

A heat generating device 80 is disposed in the cavity 14. The heat generating device 80 is connected to the main control board 20. An output port of the heat generating device 80 faces the air outlet 15 and sends warm air to the outside through the air outlet 15. In this embodiment, the heat generating device 80 is an electric heater 81. The electric heater 81 is fixed to a fixing plate 82 and connected to the main control board 20.

The working process of this embodiment is as follows:

First, when the electric fireplace is powered on, the main control board 20 controls the light-emitting device 50, the light-reflecting device 60 and the heat-generating device 80 to start working. At this time, the heat generating device 80 sends warm air to the outside through the air outlet 15. The light of the light-emitting device 50 is reflected by the light reflecting device 60 and passes through the flame-shaped holes 31. Then, the light passes through the gap 16 to form a flame-shaped burning effect on the simulated bricks 70. Since the flame-shaped light is emitted from the gap 16 between the rear inner wall of the accommodating chamber 11 and the simulated wood 40, the flame looks more three-dimensional. A part of the light blocked by the flame processing device 30 shines on the simulated wood 40. From the outside of the simulated wood 40, it looks like a flickering feeling, making the burning effect more realistic.

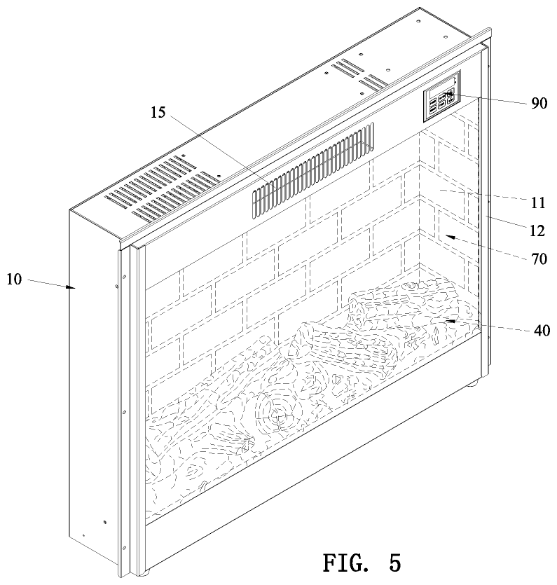

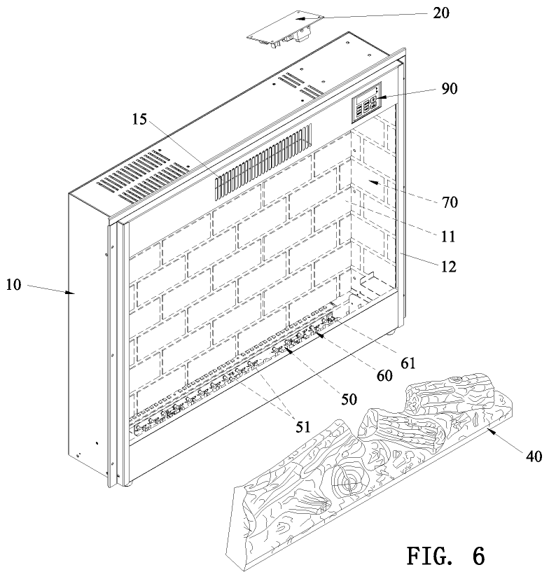

FIG. 5 and FIG. 6 illustrate the specific structure of a second embodiment of the present invention. The specific structure of the second embodiment is substantially similar to the specific structure of the first embodiment with the exceptions described hereinafter.

The light-emitting device 50 includes two light plates 51, one of which faces upward and the other of which faces frontward.

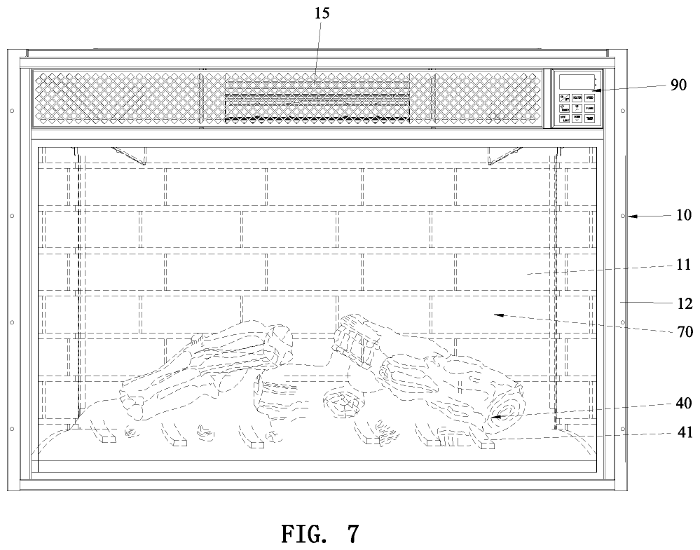

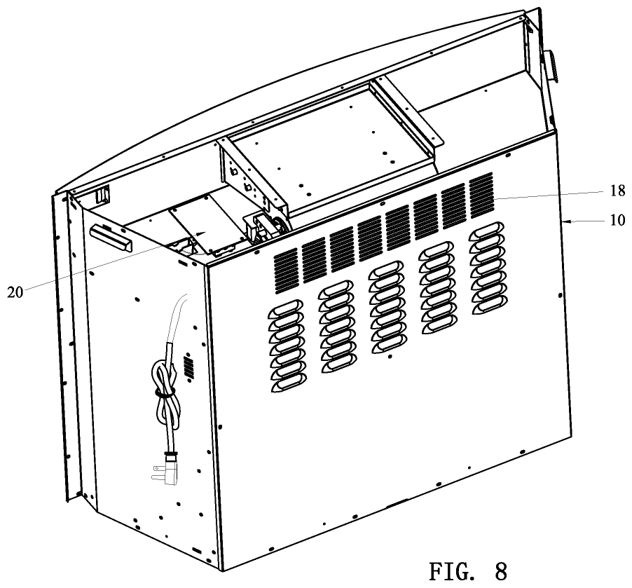

FIG. 7 and FIG. 8 illustrate the specific structure of a third embodiment of the present invention. The specific structure of the third embodiment is substantially similar to the specific structure of the first embodiment with the exceptions described hereinafter.

The front end of the housing 10 has a width greater than that of the rear end of the housing 10, and the front end of the accommodating chamber 11 has a width greater than that of the rear end of the accommodating chamber 11 to form a more realistic hole-shaped effect. The back of the housing 10 is provided with a vent 18. The vent 18 is located on the back of the upper portion of the housing 10 and communicates with the cavity 14.

The simulated wood 40 is disposed on a plurality of simulated fire grates 41.

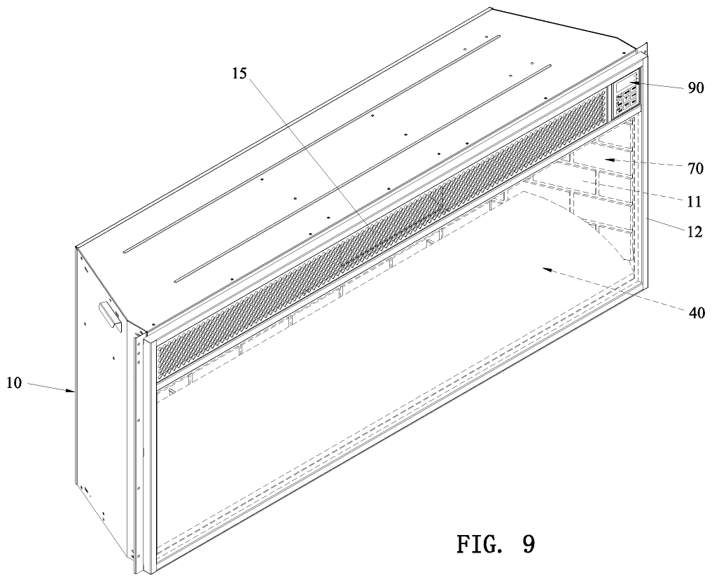

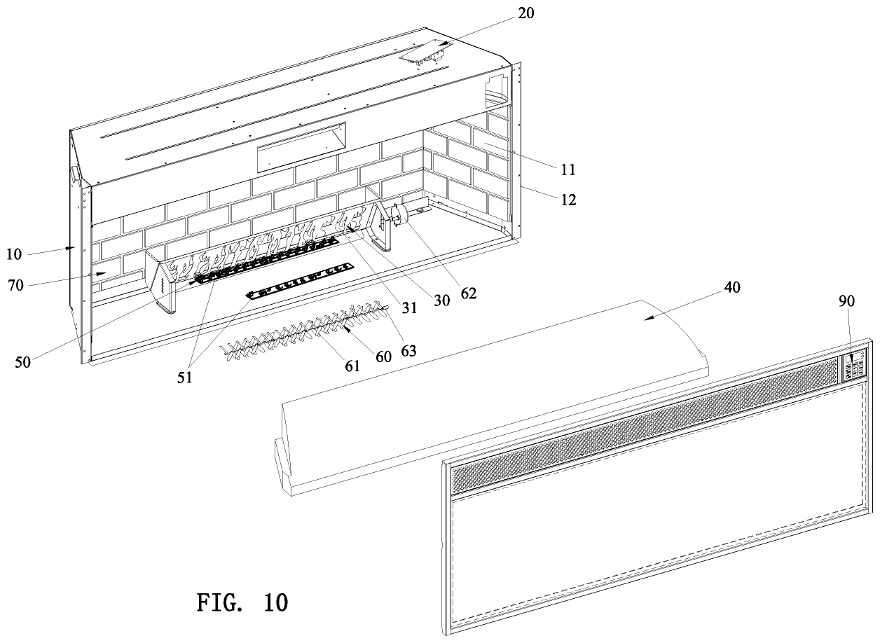

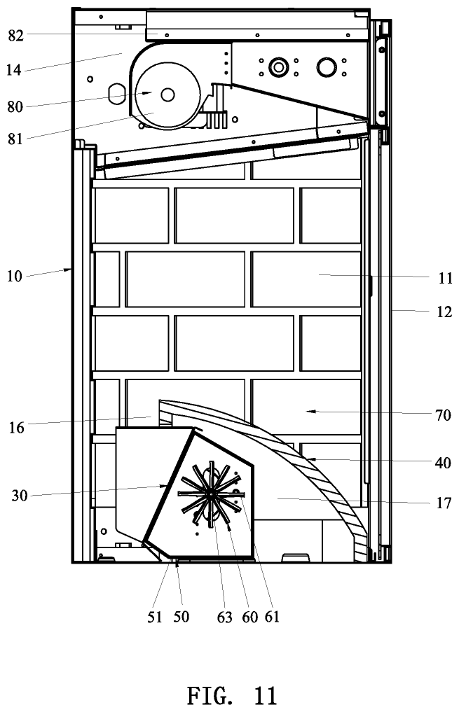

FIG. 9, FIG. 10 and FIG. 11 illustrate the specific structure of a fourth embodiment of the present invention. The specific structure of the fourth embodiment is substantially similar to the specific structure of the first embodiment with the exceptions described hereinafter.

The front end of the housing 10 has a width greater than that of the rear end of the housing 10, and the front end of the accommodating chamber 11 has a width greater than that of the rear end of the accommodating chamber 11 to form a more realistic hole-shaped effect. The flame processing device 30 and the simulated wood 40 are centrally disposed at the bottom of the accommodating chamber 11. The flame processing device 30 is located under the rear side of the simulated wood 40. The light-emitting device 50 includes two light plates 51. The two light plates 51 face upward.

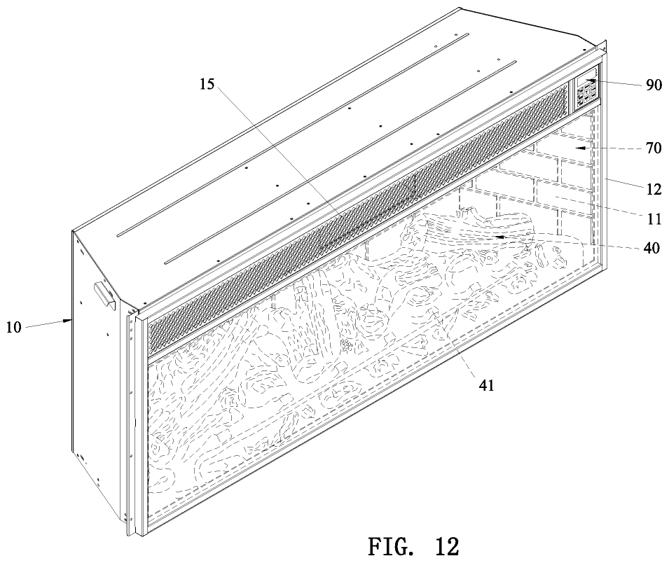

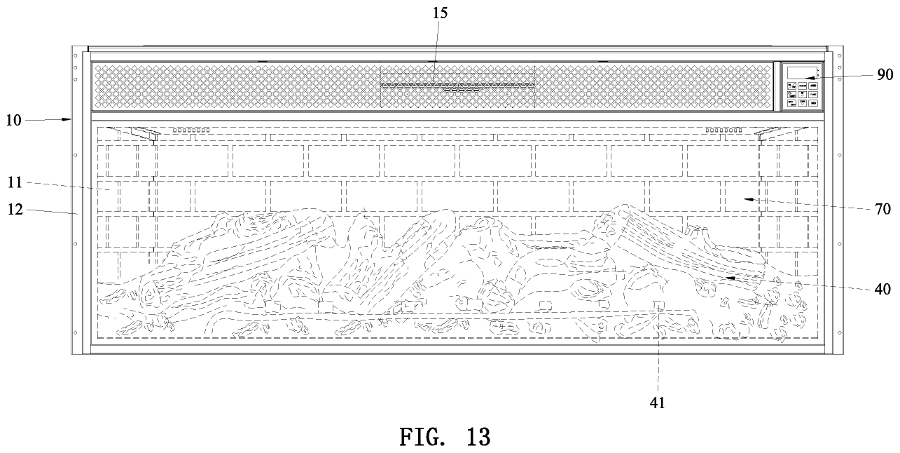

FIG. 12 and FIG. 13 illustrate the specific structure of a fifth embodiment of the present invention. The specific structure of the fifth embodiment is substantially similar to the specific structure of the first embodiment with the exceptions described hereinafter.

The front end of the housing 10 has a width greater than that of the rear end of the housing 10, and the front end of the accommodating chamber 11 has a width greater than that of the rear end of the accommodating chamber 11 to form a more realistic hole-shaped effect. The simulated wood 40 is disposed on a plurality of simulated fire grates 41.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. An electric fireplace, comprising a housing, a main control board, a flame processing device, a simulated wood, a light-emitting device, a light-reflecting device, and simulated bricks; a front of the housing being recessed to form an accommodating chamber, the accommodating chamber having an opening covered with a transparent front door; the main control board being disposed inside the housing; the flame processing device being disposed at a bottom of the accommodating chamber and located in front of a rear inner wall of the accommodating chamber; the simulated wood being disposed at the bottom of the accommodating chamber and located in front of the flame processing device, the simulated wood extending obliquely rearward and upward, a top of the simulated wood being connected to a top of the flame processing device, a gap being defined between the simulated wood and the rear inner wall of the accommodating chamber as well as between the flame processing device and the rear inner wall of the accommodating chamber, the housing having a mounting cavity surrounded by the simulated wood, the flame processing device and an inner bottom surface of the accommodating chamber; the light-emitting device and the light-reflecting device being disposed in the mounting cavity; the light-emitting device being located under the flame processing device, the light-emitting device being electrically connected to the main control board; the light-reflecting device being located obliquely above the light-emitting device and in front of the flame processing device, the light-reflecting device being connected to the main control board; the simulated bricks being attached to the inner wall of the accommodating chamber.

2. The electric fireplace as claimed in claim 1, wherein the upper inner wall of the accommodating chamber is provided with a light-blocking plate, and the light-blocking plate extends obliquely forward and upward.

3. The electric fireplace as claimed in claim 1, wherein the main control board is connected with a control panel, and the control panel is exposed at an upper right corner of the front of the housing.

4. The electric fireplace as claimed in claim 1, wherein the flame processing device is a flame-shaped retaining plate that has a plurality of flame-shaped holes and extends obliquely forward and upward.

5. The electric fireplace as claimed in claim 1, wherein the light-emitting device is an LED light source that illuminates forward and upward.

6. The electric fireplace as claimed in claim 1, wherein the light-reflecting device includes a light-reflecting beam and a motor, the light-reflecting beam is fitted on a rotating shaft, the motor is disposed on the housing and connected to one end of the rotating shaft, the motor drives the light-reflecting beam to rotate through the rotating shaft, and the motor is connected to the main control board.

7. The electric fireplace as claimed in claim 1, wherein the simulated bricks are flexible adhesive simulated bricks.

8. The electric fireplace as claimed in claim 1, wherein a top of the housing has a cavity, the front of the housing is provided with an air outlet, the air outlet is located on the front of an upper portion of the housing and communicates with the cavity; a heat generating device is disposed in the cavity, the heat generating device is connected to the main control board, and an output port of the heat generating device faces the air outlet.

9. The electric fireplace as claimed in claim 8, wherein the heat generating device is an electric heater, and the electric heater is fixed to a fixing plate and connected to the main control board.

10. The electric fireplace as claimed in claim 1, wherein a front end of the housing has a width greater than that of a rear end of the housing, and a front end of the accommodating chamber has a width greater than that of a rear end of the accommodating chamber.
